(19) United States
(12) Patent Application Publication
(10) Pub. No.: US 2017/0367518 A1
(43) Pub. Date: Dec. 28, 2017

(54) AUTOMATIC COFFEE MAKER AND METHOD OF PREPARING A BREWED BEVERAGE

(71) Applicant: SharkNinja Operating LLC, Newton, MA (US)

(72) Inventors: Joshua D. Anthony, Billerica, MA (US); Steven Toddes, Hopkinton, MA (US); Edward J. Scarsella, Brighton, MA (US); Jeremy Kuempel, Brisbane, CA (US); Matthew Walliser, San Mateo, CA (US)

(21) Appl. No.: 15/634,670

(22) Filed: Jun. 27, 2017

Related U.S. Application Data
(60) Provisional application No. 62/354,995, filed on Jun. 27, 2016.

(51) Int. Cl. A47J 31/06; A47J 31/46

(52) U.S. Cl. CPC A47J 31/0657; A47J 31/0652; A47J 31/46

(57) ABSTRACT

A beverage system includes a housing and a brew basket associated with the housing. The brew basket includes a brew chamber. A pressurization system is associated with the brew chamber. The pressurization system is selectively operable to increase a pressure within the brew chamber to control a rate at which a fluid passes through the brew chamber to an outlet formed in said brew basket.

### CROSS-REFERENCE TO RELATED APPLICATION

This application claims the benefit of U.S. Provisional Patent Application Ser. No. 62/354,995, filed Jun. 27, 2016, which is incorporated herein by reference in its entirety.

### BACKGROUND

Exemplary embodiments of the present disclosure relate to a system and method for brewing beverages, and more particularly to a system and method of automatically brewing a beverage having a desired flavor profile.

Various systems and methods for brewing a beverage, such as coffee, are known. Known systems include drip brewing systems in which hot water is filtered through coffee grounds and into a carafe and French press systems in which coffee grounds and hot water are mixed in a container and a water permeable plunger is pressed into the container from above to trap the ground coffee at the bottom of the container.

Accordingly, a beverage brewing system capable of efficiently brewing a beverage having a desired flavor profile is desirable.

### SUMMARY

According to one embodiment, a beverage system includes a housing and a brew basket associated with the housing. The brew basket includes a brew chamber. A pressurization system is associated with the brew chamber. The pressurization system is selectively operable to increase a pressure within the brew chamber to control a rate at which a fluid passes through the brew chamber to an outlet formed in said brew basket.

According to another embodiment, a method of preparing a beverage includes supplying at least a portion of a brew volume of fluid to a brew chamber and pressurizing the brew chamber to control a rate at which the at least a portion of said brew volume filters through and is output from said brew chamber.

According to another embodiment, a method of preparing a beverage includes supplying a fluid to a brew chamber of a brew basket and pressurizing the brew chamber such that said fluid filters through and is output from the brew chamber faster than if movement of said fluid through the brew chamber is driven by gravity.

According to another embodiment, a brew basket is provided including a basket body having a first end, a second end, and at least one sidewall extending between the first end and the second end to define a brew chamber. An outlet is formed in the basket body. The outlet is positioned vertically above a plane containing a maximum fluid level within said brew chamber.

According to another embodiment, a brew basket is provided including a basket body having a first end, a second end, and at least one sidewall extending between the first end and the second end to define a brew chamber. The brew chamber has an outlet formed therein. An enclosed fluid channel is connected to the outlet. The enclosed fluid channel has an outlet end positioned vertically above a plane containing a maximum fluid level within the brew chamber.

According to another embodiment, a brew basket includes a basket body having a first end, a second end, and at least one sidewall extending between the first end and the second end to define a brew chamber. The brew chamber is configured to receive and form a seal about a flat bottom of a filter.

According to another embodiment, a beverage brewing system is provided including a housing, a brew basket associated with said housing, a first conduit fluidly coupled to said brew basket, a bypass conduit having an outlet, and a valve associated with the first conduit and the bypass conduit. The valve is movable between a plurality of positions to divert a fluid flow between said first conduit and said bypass conduit.

### BRIEF DESCRIPTION OF THE FIGURES

The accompanying drawings incorporated in and forming a part of the specification embodies several aspects of the present disclosure and, together with the description, serves to explain the principles of the disclosure. In the drawings:

FIG. 1 is a graph representing Strength (% TDS) vs. Extraction (%) of Brewed Coffee;

FIG. 2 is a schematic diagram of a beverage brewing apparatus according to an embodiment;

FIG. 3 is a schematic diagram of a user interface of a beverage brewing apparatus according to an embodiment;

FIG. 4 is a schematic diagram of a pressurization system of a beverage brewing apparatus according to an embodiment;

FIG. 5 is a perspective view of a brew basket of a beverage brewing system according to an embodiment;

FIG. 6 is a cross-sectional view of a brew basket of a beverage brewing system according to an embodiment;

FIG. 7 is a cross-sectional view of a brew basket of a beverage brewing system according to an embodiment; and

FIG. 8 is a cross-sectional view of a brew basket of a beverage brewing system according to another embodiment.

The detailed description explains embodiments of the disclosure, together with advantages and features, by way of example with reference to the drawings.

### DETAILED DESCRIPTION

Aspects and embodiments disclosed herein include a system and method for preparing various brewed beverages. Although the disclosure is described herein with reference to preparing a brewed coffee beverage, preparation of other brewed beverages is within the scope of the disclosure. As the term is used herein, “coffee” refers to a beverage including solids extracted from coffee beans and dissolved in water. Brewed coffee is typically prepared by passing hot water through dried and ground coffee beans, referred to herein as “ground coffee.” Solids from the ground coffee are dissolved in the hot water as it passes there through.

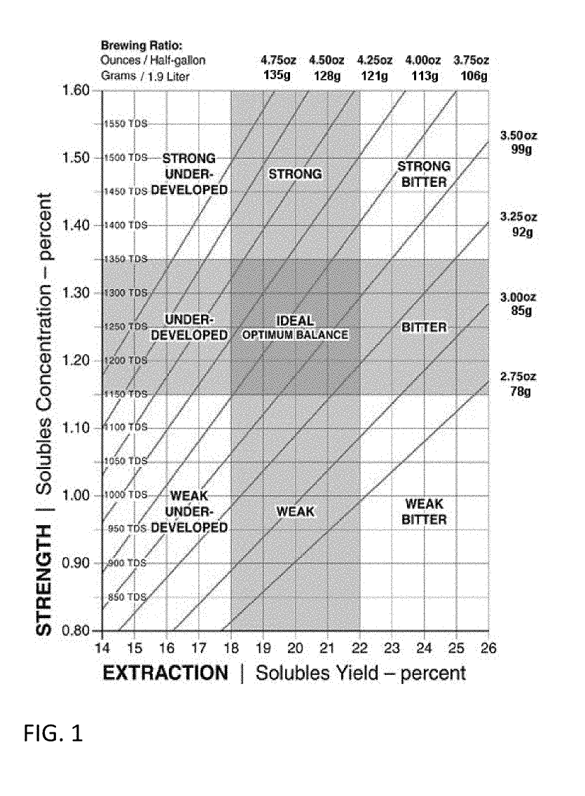

The flavor profile of brewed coffee is a balance between strength (solubles concentration) and extraction (solubles yield), as shown in FIG. 1. Strength refers to the measured amount of solids extracted into the coffee. Strength is typically expressed as a percentage of total dissolved solids (% TDS). For example, for 100 g of coffee measuring 1.2% TDS, 98.8 g of the coffee is water and 1.2 g is dissolved coffee solids. Extraction, or solubles yield, refers to the percentage of the ground coffee by weight that is removed by dissolving water during the brewing process. Up to 30% of the available soluble solids in ground coffee can be extracted, with most of the remaining 70% being insoluble in water. The solubles yield of brewed coffee is dependent on multiple factors, including, but not limited to, the temperature of the water passed through the ground coffee, the grind size of the ground coffee, and the amount of time that the water is in contact with the ground coffee. For example, ground coffee with a larger grind size may require a higher water temperature or a longer water contact time at a lower temperature to achieve an equivalent amount of soluble extraction as a ground coffee having a smaller grind size.

Over the years, various institutions and committees within the coffee industry have established a “gold cup” standard that coffee having an extraction between about 18% and 22% and a percentage of total dissolved solids between about 1.15 and 1.35 percent will generally yield the best quality of brewed coffee. As shown in the FIG., coffee with an extraction of greater than 22% will have a sharp increase in the soluble components that contribute to the bitter taste associated with over-extraction, and coffee with an extraction of less than 18% is generally associated with sour, under-developed taste.

The amount of water used to brew the coffee should also be controlled to produce a coffee having a pleasant flavor and strength. The strength of the coffee will vary depending on multiple factors including, the ratio of ground coffee to water being used, grind size, and contact time between the coffee grounds and the water for example. In a general application, the use of too much water may result in coffee that is weak, and the use of too little water may result in coffee which is undesirably strong.

The temperature of the water used is also considered an important variable in determining a proper balance and taste. This is because cooler water may not extract a desirable quantity of solubles that make up the flavor of brewed coffee. Similarly, hotter water may extract a higher ratio of bitter solubles than desired. As a result, it is generally desirable to use water for brewing coffee such that temperature in the brewing chamber is between about 195° F. and 205° F. (91° C.-96° C.).

It is known that pre-soaking or wetting the ground coffee with water, such as prior to delivering the majority of the hot water used to brew the coffee, may result in a brewed coffee having a more pleasant taste than brewed coffee produced without pre-soaking the ground coffee. Pre-soaking the ground coffee releases gasses trapped within the coffee grounds, such as carbon dioxide for example. As a result, the portion of the ground coffee configured to evenly absorb and filter the water is increased. The water used for pre-soaking the ground coffee may be referred to herein as “bloom water” and the amount of time that the boom water is exposed to the ground coffee to pre-soak the ground coffee is referred to as “bloom time.” The water used to brew the coffee from the ground coffee after the bloom water, will be referred to herein as “brew water.” The brew water is delivered to the ground coffee after completion of pre-soaking of the ground coffee with the bloom water for a bloom time. The ratio of the volume of bloom water to the mass of ground coffee, in addition to other factors, also contributes to the production of a balanced, pleasant tasting coffee.

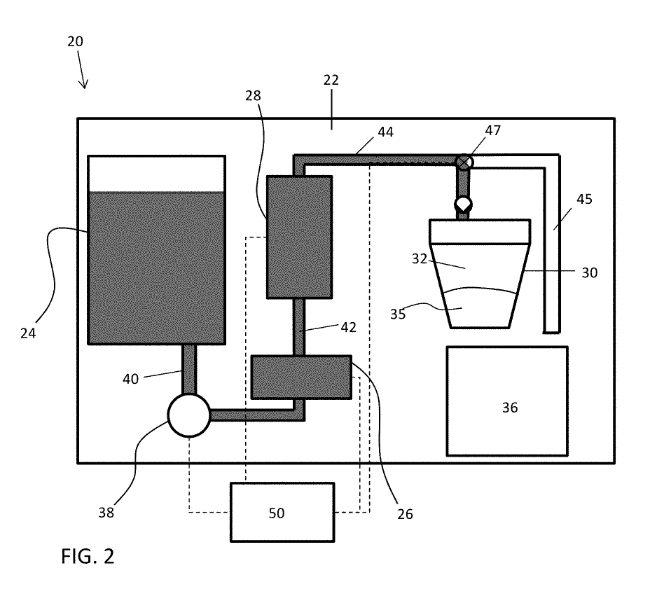

Referring now to FIG. 2, a schematic diagram of an example of a basic, automated beverage brewing apparatus 20 is illustrated. The apparatus 20 includes a housing 22, a reservoir 24, a pumping mechanism 26, a heating mechanism 28, and a brew basket 30. The reservoir 24, pumping mechanism 26, heating mechanism 28, and brew basket 30 are arranged sequentially in fluid communication. Upon activation of the apparatus 20, the pumping mechanism 26 draws water or another fluid from the reservoir 24 and pumps the fluid through the heating mechanism 28 to the brew basket 30. As the fluid passes through the heating mechanism 28, the fluid is heated to a desired temperature before being distributed onto coffee grounds or another flavorant 35 contained within an interior brew chamber 32 of the brew basket 30. After having filtered through the flavorant 35, the fluid containing a portion of the flavorant 35 is output to a container 36 via an outlet of the brew basket 30 for consumption.

As shown the pumping mechanism 26 is fluidly coupled to the water reservoir 24 with a first conduit 40, the pumping mechanism 26 is fluidly coupled to the heating mechanism 28 via a second conduit 42, and the heating mechanism 28 is fluid coupled to the brew basket 30 with a third conduit 44. Although each of the first, second, and third conduits 40, 42, 44 is illustrated as a single conduit, embodiments including a plurality of conduits are also contemplated herein. The first, second, and third conduits 40, 42, 44 may be formed from the same or different food safe materials, such as food grade silicone tube, stainless steel tubing, or polymeric tubing for example. In an embodiment, the pumping mechanism 26 is a solenoid water pump and the heating mechanism 28 is a flow through heater. However, it should be understood that any suitable pumping mechanism and heating mechanism are considered within the scope of this disclosure.

The brew basket 30 may be movably coupled to the beverage brewing system 20. When the brew basket 30 is in an installed position, an open upper end 34 of the brew basket 30 is arranged in sealing engagement with an adjacent component of the beverage brewing system 20, such as the housing 20 for example.

In some embodiments, the pumping mechanism 26 is configured to operate for a predetermined period of time to supply a predetermined amount of fluid to the brew chamber 32 based on the size of the beverage being prepared. Alternatively, or in addition, a flow meter 38 may be arranged within a passage extending between the water reservoir 24 and the pumping mechanism 26 to monitor the amount of fluid that passes there through. The amount of fluid that passes through the flow meter 38 may also be indicated of the amount of fluid provided to the brew chamber 32 of the brew basket 30. Various types of flow meters are within the scope of the disclosure.

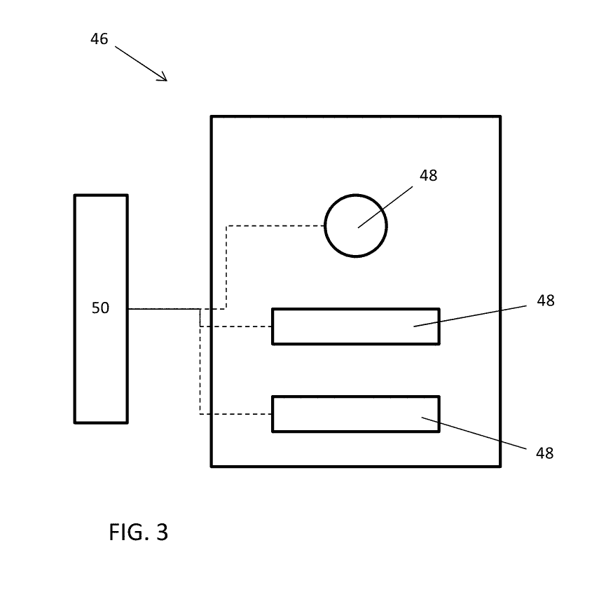

The beverage brewing apparatus 20 additionally includes a user interface, illustrated schematically at 46 in FIG. 3. The user interface 46 may include one or more buttons, knobs, or other control input devices 48, such as for providing one or more inputs to the system. Examples of such inputs include, but are not limited to a desired size, strength, or type of beverage to be brewed.

Operation of the beverage brewing apparatus 20 is controlled by a controller 50 operably coupled to the pumping mechanism 26, the heating mechanism 28, the venting mechanism, and the one or more input devices 46 of the user interface 44. The controller 50 is configured to operate the pumping mechanism 26 and the heating mechanism 28 to brew a beverage in response to the input signals received from the input devices 48. The controller 50 may include one or more or a microprocessor, microcontroller, application specific integrated circuit (ASIC), or any other form of electronic controller known in the art.

In an embodiment, as shown in FIG. 2, a bypass conduit 45 may be fluidly coupled to the third conduit 44 by a valve 47. The valve 47 may be operably coupled to the controller 50 for rotation between a plurality of positions. Operation of the valve 47 may be controlled to selectively direct a flow of heated fluid directly to the container 36 instead of to the brew basket 30. In some embodiments, an attachment or other component (not shown) associated with the beverage brewing system 20 may be configured to connect to the outlet of the bypass conduit 45.

The bypass conduit 45 may be particularly useful during the preparation of large quantities of a beverage. For example, when the valve 45 is in a first position, a small, concentrated volume of a brewed beverage is prepared by supplying a portion of fluid to the flavorant 35 in the brew basket 30. The controller 50 may automatically operate the valve 47 to a second positon, to supply additional hot fluid, for example hot water, directly to the container 36 without passing through the brew basket 30. The mixture of the concentrated brewed beverage and the hot fluid within the container 36 forms a brewed beverage having a desired flavor profile. In addition, as fluid passes through the flavorant 35 in the brew basket 30, the temperature of the fluid may decrease. Fluid provided directly to the container 36 via the bypass conduit 45 may be used to increase the overall temperature of the brewed beverage within the container 36 because the temperature of the bypass fluid is typically greater than the temperature of the fluid output from the brew basket 30.

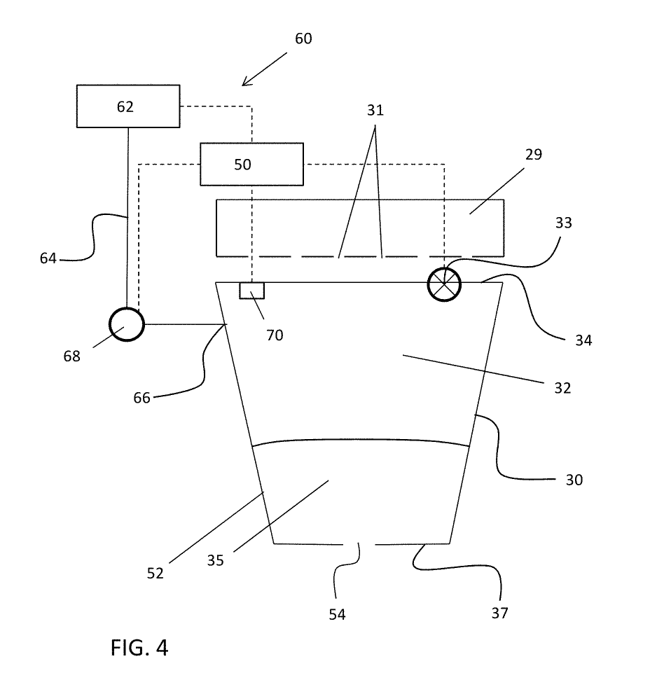

With reference now to FIG. 4, the beverage brewing system 20 includes a pressurization system 60 fluidly coupled to the interior 32 of the brew basket 30. The pressurization system 60 is configured to selectively increase the pressure within the brew chamber 32 to control the rate at which fluid within the brew chamber 32 seeps or otherwise passes through the quantity of flavorant 35 stored therein. The pressurization system 60 includes a pressure source 62 operably coupled to the controller 50, such as a motorized air pump or pressure pump for example, fluidly connected to the interior 32 of the brew basket 30. Alternatively, or in addition, the pumping mechanism 26 and heating mechanism 28 in combination may be configured as a pressure source operable to pressurize the interior of the brew chamber 32, such as by providing steam thereto for example.

In an embodiment, a conduit 64 extending between the pressure source 62 and the brew basket 30 may connect to an inlet 66 formed in a sidewall 52 of the brew basket 30, such as above the highest brew level of the brew basket 30 for example, to define a pathway for the pressure supply. Alternatively, a portion of the passageway through which a fluid is provided from the reservoir 24 to the brew basket 30 may also define a pathway for a pressure supply to the brew chamber 32. In embodiments where the brew basket 30 is positioned directly adjacent a shower head 29 having a plurality of openings 31 used to distribute fluid over the flavorant 35 in the brew chamber 32, pressure generated by the pressure source 62 may pass through one or more of the openings 31 to the brew chamber 32. In another embodiment, an additional opening, such as having a different size or shape than openings 31, may be formed in a portion of the shower head 29 and may be coupled to a conduit 64 to function as a pressure inlet 66 to the brew chamber 32.

The conduit or pathway 64 may, but need not include a valve 68 movable between a plurality of positions to control a volume of pressurized air or steam provided to the brew chamber 32. One or more pressure sensors 70 may be configured to monitor and provide feedback regarding the pressure within the chamber 32. A controller, such as controller 50 for example, may be configured to operate the pressure source 62 and/or the valve 68 in response to information provided by the pressure sensor 70.

In an embodiment, a valve or other venting mechanism associated with the brew chamber 32 of the brew basket 30, and illustrated schematically at 33, may be operated to break the seal between the brew basket 30 and the adjacent component such that pressure is vented or release from the brew chamber 32 to the atmosphere. The valve may be operably coupled to the controller of the pressurization system 60, or the controller 50 of the beverage brewing system 20.

Preparation of a beverage using the beverage brewing system 20 typically includes providing a volume of bloom water or fluid to the brew chamber 32, and then after waiting a predetermined period of time, supplying a volume of brew water or fluid to the brew chamber 32. The volume of bloom water supplied varies based on one or more parameters of the beverage being brewed, such as the size and type of beverage for example. Typically, the amount of bloom water supplied to the brew basket 30 is sufficient to moisten a portion or all of the flavorant within the brew chamber 32, but is insufficient to cause a significant amount of, or any, water to exit into the container 32. The volume of brew water provided to the brew basket 30 produces a coffee or other beverage by passing through the soaked flavorant into the adjacent container 36. The volume of brew water may be provided to the brew basket 30 as a single volume, or as a plurality of distinct volumes.

The pressurization system 60 may be used at any time during the preparation of a brewed beverage after a volume of fluid has been provided to the brew chamber 32. For example, after supplying all or a portion of the volume of brew water to the brew chamber 32, the pressurization system 60 may be operated to increase the pressure between the surface of the fluid within the chamber 32 and the upper surface 34 of the brew basket 30 substantially sealed against an adjacent component of the beverage brewing system 20. The application of pressure will cause the fluid to filter through the flavorant more quickly, such as in less than 20 seconds for example, resulting in a hotter beverage. Embodiments where the pressurization system 60 is operated when no fluid is within the brew chamber 32, for example to clean the fluid passageway leading to the brew basket 30, are also contemplated herein.

In an embodiment, the pressurization system 60 may be operated after an initial portion of the brew volume is supplied to the brew chamber 32, but before a second portion of the brew volume is supplied to the brew chamber 32. Application of such a pressure in the middle of the brewing operation may be used to expel substantially all of the first portion of brew volume from within the chamber 32. The additional fluid provided as the second portion of the brew volume may then draw additional solids from the flavorant 35 that would not have been absorbed by the first portion which was already saturated. As a result, the beverage output from the system 20 may have an increased amount of solids, and therefore flavor.

In another embodiment, the pumping mechanism 26 and heating mechanism 28 and a separate pressure source 62 may be configured to cooperate to pressurize the brew chamber 32 at various stages during a brew cycle. After supplying a first portion of brew volume to the brew chamber 32, the pumping mechanism 26 and heating mechanism 28 may cooperate to perform a first pressurization by supplying steam to the brew chamber 32. The steam is used to expel substantially all of the first portion of brew volume from the chamber 32 while still maintaining a high temperature within the chamber 32. After a second subsequent portion of brew volume is supplied to the brew chamber 32, the pressure source 62 may then be used to perform a second pressurization of the brew chamber 32. The second pressurization expedites the filtering of the second portion of the brew volume through the flavorant 35 in the brew chamber 32.

Although the pumping mechanism 26 and heating mechanism 28 are described as performing a first pressurization and a separate pressure source 62 is described as performing a second pressurization, it should be understood that embodiments where the pressure source 62 performs the first pressurization and the pumping mechanism 26 and heating mechanism 28 perform the second pressurization, or embodiments where either the pumping mechanism 26 and heating mechanism 28 together, or the pressure source 62 performs both the first and second pressurizations is within the scope of the disclosure. In addition, it should be understood that the description regarding preparation of the beverage including a single pressurization or a first pressurization and a second pressurization are intended as an example only, and any number of pressurizations performed during the preparation of a brewed beverage is considered within the scope of the disclosure.

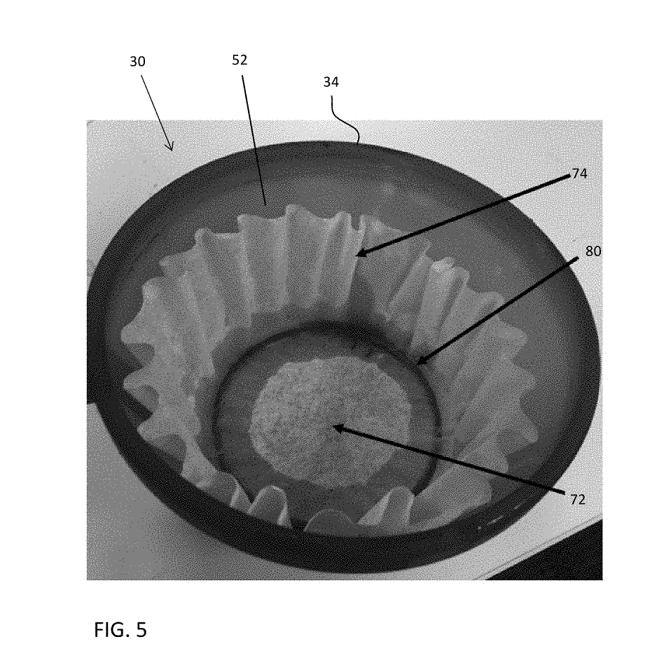

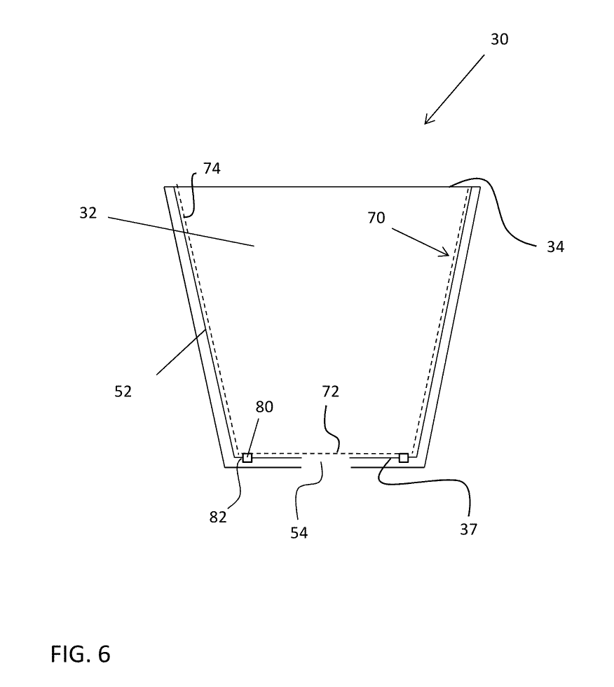

An example of the brew basket 30 is illustrated in more detail in FIGS. 5-6. As shown, the brew basket 30 includes a first end 34, a second end 37 (FIG. 2), and one or more sidewalls 52 extending there between. The sidewalls 52 define the interior volume of space or brew chamber 32 within which one or more products 35 associated with the beverage brewing process are positioned. The second end 37 of the brew basket 30 is generally closed or sealed and the first end 34 of the brew basket 30 is open such that products may be inserted into the chamber 32 of the brew basket 30 via the first end 34.

The brew chamber 32 may be configured to receive a disposable or permanent coffee filter (not shown) in which the flavorant, such as ground coffee, espresso, or tea for example, is contained. In the illustrated, non-limiting embodiment, a cross-sectional area of the chamber 32 adjacent the first end 34 is substantially larger than at the second end 37 such that the brew basket 30 is generally frustoconical in shape. However, embodiments where the brew basket 30 has another shape, such as where the brew basket 30 is generally cylindrical for example, are also contemplated herein. One or more openings 54 (FIG. 2) are formed in the brew basket 30 as an outlet from which a fluid filtered through the flavorant 35 may be provided to a container 36.

In the embodiment of FIG. 5, the brew basket 30 is configured for use with a filter 70 having a flat-bottom 72. Commercially available filters 70 having a flat bottom 72 are typically referred to as 8-12 cup basket type filters. The flat-bottomed filter 70 may be just a disc positionable within the brew chamber 32 generally adjacent the second end 37 of the brew basket 30, or alternatively, may include sides 74 that extend generally parallel to the sidewall 52 as shown in the FIG. In embodiments where the filter is a disc, the disc may be formed from a paper material, or may be formed from a metal mesh or screen. In some embodiments, the metal mesh disc may be removably or integrally formed with brew basket 30. In embodiments where the filter is a commercially available filter 70 having pleated sides 74, the sides 74 may affect the ability to build up pressure within the brew chamber 32. Accordingly, flat-bottomed filters 70 are typically not conducive for brewing beverages of smaller volumes, such as a single serving for example, because the depth of the flavorant 35 positioned within the filter 70 is too shallow for proper extraction to occur.

To adapt the system 20 for improved use with a removable flat-bottom filter 70, a seal 80 is positioned adjacent the flat-bottom 72 of the filter 70. The seal 80 may extend about the periphery of the flat-bottom portion 72 of the filter 70 and may be received within a corresponding groove 82 (FIG. 6) formed in an adjacent portion of the brew basket 30, or may be integrally formed with the bottom of the brew chamber 32. The seal 80 may be located underneath the flat-bottom 72, or alternatively, may be installed over the filter 70 such that a portion of the filter 70 is received within the corresponding groove 82 in addition to the seal 80. By locating the seal 80 adjacent the flat bottom 72 of the filter 70, the sides 74 of the filter 70 are sealed against creating an air bypass. As a result, inclusion of the seal 80 forces brewing to occur only at the flat-bottom 72 of the filter 70 and not at the sides 74, thereby allowing the buildup of pressure within the brew chamber 32.

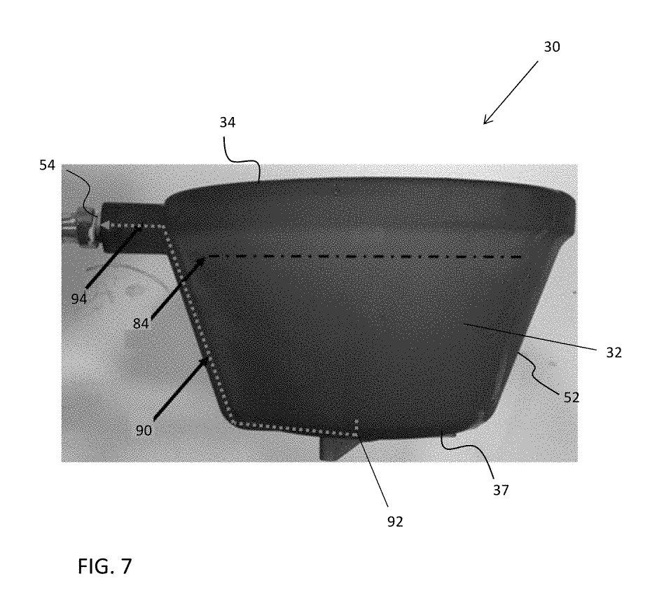

In another embodiment, as shown in FIG. 7, the outlet 54 of the brew basket 30 is located at a position vertically above the highest brew level of the brew basket 30, as indicated schematically at 84. In the illustrated, non-limiting embodiment, the outlet 54 is positioned generally adjacent the first end 34 of the brew basket 30; however, it should be understood that a brew basket 30 having an outlet 54 located at any position between the first end 34 and the second end 37, or alternatively, vertically above both the first end 34 and the second end 37 is also considered within the scope of the disclosure. In an embodiment, an enclosed fluid channel 90 arranged within the brew chamber 32 fluidly couples the brew chamber 32 and the outlet 54. The enclosed fluid channel 90 extends generally parallel to the sidewall 52 of the brew basket 30 and includes an inlet end 92 positioned generally adjacent the second end 37 of the brew basket 30 to capture fluid after it has filtered through the flavorant 35.

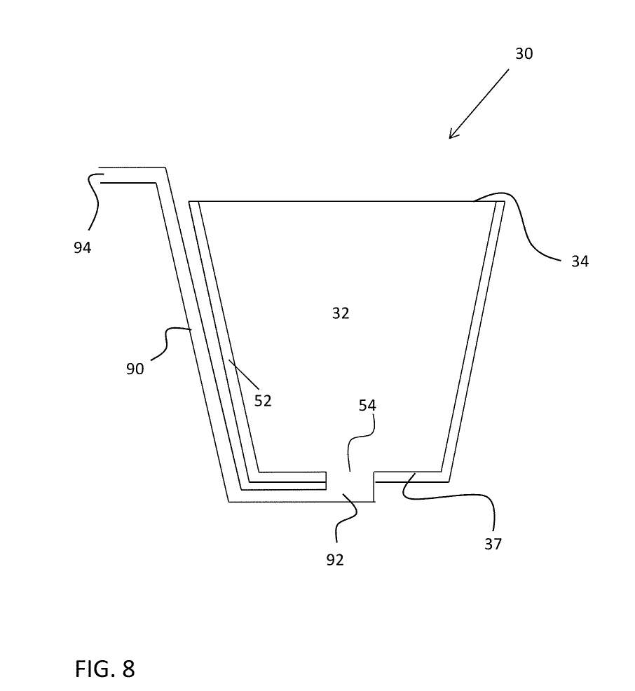

In another embodiment, as shown in FIG. 8, the outlet 54 formed in the brew basket may be located at any location, but an outlet end 94 of the enclosed fluid channel 90 coupled to the outlet 54 is arranged at a position vertically above the highest brew level of the brew basket 30. In such embodiments, the enclosed fluid channel 90 may be arranged outside of the brew chamber 32, and may but need not be removably coupled to the brew basket 30.

In either embodiment, because the outlet end 94 of the enclosed fluid channel 90 is arranged vertically above the inlet end 92 and above the highest brew level 84, the enclosed fluid channel 90 will fill with fluid only to a level equal to or within the same horizontal plane as the highest brew level 84 due to pressure equalization. As a result, application of pressure to the sealed brew chamber 32, such as via the pumping mechanism 26 and heating mechanism 28 or pressure source 62 of the pressurization system 60 for example, is necessary to move the filtered fluid through the pipe 90 in a direction opposite gravity.

During the preparation of a brewed beverage, a bloom volume of fluid may be provided to the brew chamber 32 to saturate the flavorant 35 therein. During the bloom period of the brew cycle, pressure need not be applied to the sealed brew chamber 32. Due to the configuration and lack of pressure, none of the bloom water will be provided from the brew basket 30 to the adjacent container 36. After waiting a desired period of time to allow the wetted flavorant 35 to off-gas, all or a portion of the brew volume of fluid is provided to the brew chamber 32. When one or more portions of brew volume are provided to the brew chamber 32, the level of fluid within the chamber 32 does not exceed the highest brew level 84. However, as the brew volume is added to the brew chamber 32, the pressure within the brew chamber 32 increases causing at least a portion of the brew volume added to flow through the outlet 94 of the enclosed fluid channel 90 to an adjacent component, such as a container 36 for example.

To expel the entire portion of the brew volume added to the brew chamber 32, the pressure source 62 or the combination of the pumping mechanism 26 and the heating mechanism 28 may be operated to increase the pressure within the brew chamber 32, thereby causing the fluid to filter more quickly through the flavorant 35, and move through the enclosed fluid channel 90 to the outlet 94 thereof. Because pressure is necessary to propel the fluid within the chamber 32 through the enclosed fluid channel 90, the pressure source 26, 62 may be operated to allow a consumer to selectively stop or interrupt the flow of brewed beverage to the container 36. Only once the pressure of the chamber 32 has been reestablished will the flow resume. Further, the venting mechanism 33 associated with the brew chamber 32 may be selectively operated during any portion of the brewing process to relieve pressure within the brew chamber 32.

Pressurization of the brew chamber 32 allows for repositioning of the outlet 54 relative to the brew basket 30. Repositioning of the outlet 54 provides added design flexibility to the system 20 because the brew basket 30 is no longer required to be disposed vertically above the container 36 such that the brewed beverage is provided to the container 36 via gravity. Accordingly, the brew basket 30 may be located at any position within the housing 22, such as laterally adjacent to or offset from the container 36 for example. In addition the brew basket 30 may be arranged such that all or a portion of the brew basket is arranged within the same horizontal plane as the container 36, thereby reducing the vertical height of the beverage brewing system 20. For example, the outlet 54 of the brew basket 30 may be arranged within a plane disposed vertically below the inlet opening of the container 36. The position of the brew basket 30 may be selected to optimize one or more operating parameters of the system 20.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Exemplary embodiments of this disclosure are described herein, including the best mode known to the inventors for carrying out the disclosure. Variations of those embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A beverage system, comprising:
a housing;
a brew basket associated with said housing, said brew basket including a brew chamber; and
a pressurization system associated with said brew chamber, said pressurization system being selectively operable to increase a pressure within said brew chamber to control a rate at which a fluid passes through the brew chamber to an outlet formed in said brew basket.

2. The system according to claim 1, wherein said pressurization system includes a pressure source, said pressure source being arranged in fluid communication with said brew chamber via a pressure passageway.

3. The system according to claim 2, wherein said pressure source is an air pump.

4. The system according to claim 2, further comprising a heating mechanism for supplying a heated fluid to the brew chamber, said heating mechanism being configured as said pressure source.

5. The system according to claim 4, wherein said pressure passageway is distinct from a flow path for providing said heated fluid from said heating mechanism to said brew chamber.

6. The system according to claim 4, wherein at least a portion of said pressure passageway is part of a flow path for providing said heated fluid to said brew chamber.

7. The system according to claim 2, further comprising a valve disposed within said pressure passageway, said valve being movable between a plurality of positions to control a volume of pressurized fluid provided to said brew chamber.

8. The system according to claim 2, further comprising at least one sensor configured to sense said pressure within said brew chamber, wherein operation of said pressurization system is controlled in response to said sensed pressure.

9. The system according to claim 1, wherein said brew chamber is substantially sealed during operation of the beverage system.

10. A method of preparing a beverage comprising:
supplying at least a portion of a brew volume of fluid to a brew chamber; and
pressurizing said brew chamber to control a rate at which said at least a portion of said brew volume filters through and is output from said brew chamber.

11. The method according to claim 10, wherein said brew chamber is not pressurized directly after said supplying said bloom volume of during said predetermined bloom time.

12. The method according to claim 10, wherein said pressurizing said brew chamber is configured to desiccate said flavorant within said brew chamber.

13. The method according to claim 10, further comprising:
supplying a bloom volume of fluid to a brew chamber of a brew basket;
waiting a predetermined bloom time.

14. The method according to claim 10, further comprising:
supplying another portion of said brew volume of fluid to said brew chamber; and
pressurizing said brew chamber to control a rate at which said another portion of said brew volume filters through and is output from said brew chamber.

15. The method according to claim 14, wherein a first pressure source is configured to pressurize said brew chamber after said at least a portion of said brew volume is supplied to said brew chamber and a second pressure source is configured to pressurize said brew chamber after said another portion of said brew volume is supplied to said brew chamber.

16. The method according to claim 15, wherein at least one of said first pressure source and said second pressure source is an air pump.

17. The method according to claim 15, wherein at least one of said first pressure source and said second pressure source is a pumping mechanism and a heating mechanism operated in combination.

18. A method of preparing a beverage comprising:
supplying a fluid to a brew chamber of a brew basket; and
pressurizing said brew chamber such that said fluid filters through and is output from said brew chamber faster than if movement of said fluid through said brew chamber is driven by gravity.

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)
